(19) United States
(12) Patent Application Publication
(10) Pub. No.: US 2016/0326407 A1
(43) Pub. Date: Nov. 10, 2016

(54) ADHESIVE TAPE AND ELECTRONIC APPARATUS

(71) Applicant: DIC CORPORATION, Tokyo (JP)

(72) Inventors: Takeshi IWASAKI, Saitama (JP); Hideaki TAKEI, Saitama (JP); Yuki KOMATSUZAKI, Saitama (JP)

(21) Appl. No.: 15/023,343

(22) PCT Filed: Sep. 3, 2014
(86) PCT No.: PCT/JP2014/073172

§ 371 Date: Jul. 19, 2016

(30) Foreign Application Priority Data
Sep. 20, 2013 (JP) 2013-195478

(51) Int. Cl. C09J 7/02; G06F 3/01; G06F 3/041

(52) U.S. Cl. CPC C09J 7/0289; G06F 3/041; G06F 3/016; C09J 2203/326; C09J 2423/006; C09J 2433/00

(57) ABSTRACT

The present invention provides an adhesive tape capable of giving a tactile feedback when being used for fixing a component of a touch panel device having the function of sensing contact with an object and giving a tactile feedback. The present invention relates to an adhesive tape including a foam substrate layer and an adhesive layer, wherein the adhesive tape is used for fixing a touch panel device having the function of sensing contact with or approach to the touch panel device and giving tactile feedback, and when the adhesive tape is compressed in the thickness direction with a compressive load of 5 N/cm², a displacement is 12 μm or more and less than 130 μm.

### TECHNICAL FIELD

The present invention relates to an adhesive tape used for fixing a casing and a touch-panel device having a touch feedback function.

### BACKGROUND ART

In recent years, small electronic apparatuses with a touch-panel function have been widely spread as those such as an electronic organizer, a cellular phone, PHS, a smartphone, a digital camera, a music player, a television, a notebook computer, a tablet computer, a game machine, a car navigation system, etc.

However, beginners and elderly persons never having used the electronic apparatuses are often inexperienced in touch-panel operation and may cause an error in operation of the electronic apparatuses.

A known function of preventing the operation error is a so-called touch feedback function of being capable of simply and precisely confirming whether or not an operation input to a touch panel is received by an electronic apparatus.

A function investigated as the touch feedback function is, for example, a function (tactile feedback function) that when an operation of a touch panel is received by an electronic apparatus, the electronic apparatus or the touch panel is vibrated, and the vibration allows an operator to recognize that the input operation is received (refer to, for example, Patent Literatures 1 and 2).

Also, the touch feedback function has recently been applied to, for example, a technique for enabling simulated experience of tactile feeling of a matter displayed on a screen when a touch panel or the like is touched.

Specifically, a method known as the tactile feedback function is to vibrate the whole or a portion of a touch panel by a vibration source such as a piezoelectric element (also referred to as a piezoelement), a vibration motor, a linear vibration actuator, an ultrasonic motor, or the like which is attached to a touch panel or a display module with a touch panel function (refer to, for example, Patent Literature 3). The function has an advantage that vibration can be directly transmitted to a fingertip or the like in contact with the surface of the touch panel when the touch panel is operated and that a tactile feeling similar to a click feeling generated by pressing a usual button can be given to an operator.

On the other hand, in order to prevent a mistake or operation error by an operator, the vibration or tactile feeling similar to a click feeling is preferably given when the operator pushes in (input) a touch panel portion with micro-pressure, not when the operator simply touches the touch panel.

However, an adhesive tape generally used for fixing a touch panel portion and a casing does not have the characteristic of being slightly displaced (compressed) in corresponding to push-in displacement of the touch panel portion when the surface of the touch panel portion is slightly pushed in, and thus vibration or the like corresponding to the pushing-in may not be given to the operator.

Although the vibration or the like generated by sensing the pushing-in is transmitted to a fingertip as well as the touch panel portion through the adhesive tape, the usual adhesive tape has a problem that transmission of the vibration may be inhibited, or the vibration is transmitted to the side (the casing side) opposite to the touch panel portion.

The adhesive tape is required to be further thinned with thinning and miniaturization of the electronic apparatuses, but in a present situation, there has not yet been found a thin adhesive tape capable of very small displacement corresponding to a very small pushing-in amount of the touch panel without inhibiting the transmission of vibration to the touch panel portion and a fingertip.

### CITATION LIST

### Patent Literature

PTL 1: Japanese Unexamined Patent Application Publication No. 2010-134909

PTL 2: Japanese Unexamined Patent Application Publication No. 2011-44126

PTL 3: Japanese Unexamined Patent Application Publication (Translation of PCT Application) No. 2010-506499

### SUMMARY OF INVENTION

### Technical Problem

A problem to be solved by the present invention is to provide a thin adhesive tape having a so-called touch feedback characteristic that very small displacement (compression) can be produced corresponding to a very small pushing-in amount of a touch panel portion and transmission of vibration to the touch panel portion and a fingertip is not inhibited.

A second problem to be solved by the present invention is to provide an adhesive tape being excellent in the touch feedback characteristic, impact resistance at a level usable for manufacturing the mobile apparatuses, and followability to an irregular surface of an adherend.

### Solution to Problem

The inventors found that the problems can be solved by an adhesive tape having a displacement of 12 μm or more and less than 130 μm when compressed with a compressive load of 5 N/cm².

That is, the present invention relates to an adhesive tape including a foam substrate layer and an adhesive layer, wherein the adhesive tape is used for fixing a touch panel device having the function of sensing contact with the touch panel device and giving tactile feedback, and when the adhesive tape is compressed in the thickness direction with a compressive load of 5 N/cm², a displacement is 12 μm or more and less than 130 μm.

### Advantageous Effects of Invention

An adhesive tape of the present invention has a so-called touch feedback characteristic that very small displacement (compression) can be produced corresponding to a very small pushing-in amount of a touch panel portion and transmission of vibration to the touch panel portion and a fingertip is not inhibited, and thus the adhesive tape can be manly used for fixing a casing and a touch panel device having a touch feedback function.

Also, the adhesive tape of the present invention is excellent in the touch feedback characteristic, impact resistance, followability to irregularities of a surface of an adherend, and peeling resistance, and thus can be preferably used for manufacturing a portable electronic device which is liable to be dropped, particularly a portable electronic device such as a smartphone, a tablet computer, a notebook computer, or a game machine, which is highly requested to have impact resistance with increasing screen sizes.

### BRIEF DESCRIPTION OF DRAWINGS

FIG. 1 is a conceptual diagram of a test piece used in an impact resistance test as viewed from an upper surface.

FIG. 2 is a conceptual diagram of a test piece used in an impact resistance test as viewed from an upper surface.

FIG. 3 is a conceptual diagram of a test method for impact resistance test.

### DESCRIPTION OF EMBODIMENTS

An adhesive tape of the present invention includes a foam substrate layer and an adhesive layer and is used for fixing a touch panel device having the function of sensing contact with or approach to the touch panel device and giving tactile feedback, wherein when the adhesive tape is compressed in the thickness direction with a compressive load of 5 N/cm², a displacement is 12 μm or more and less than 130 μm. The adhesive tape can be manly used for fixing a casing and a touch panel device having a touch feedback function.

The touch feedback characteristic represents the characteristic of giving vibration (tactile feedback) to an object such as a finger, a touch pen, or the like, for example, when the object such as a finger or a touch pen comes in contact with a touch panel device mounted on an electronic terminal or the like. The touch feedback characteristic includes the characteristic of sensing the approach when an object such as a finger, a touch pen, or the like comes close to the touch panel device and then sensing contact and giving vibration (tactile feedback) to the object when the object comes in contact with the touch panel device.

The adhesive tape used has a displacement of 12 μm or more and less than 130 μm when compressed with a load of 5 N/cm² in the thickness direction.

In order to satisfy both the thinning of the adhesive tape and the touch feedback characteristic, the displacement is preferably in a range of 12 μm or more and 100 μm or less and more preferably 20 μm to 100 μm.

By using the adhesive tape having the displacement, floating or peeling caused by excessive deformation of the adhesive tape of a component fixed with the adhesive tape can be preferably prevented.

The displacement during compression with a compressive load of 5 N/cm² represents a value measured by a method described below in (1) and (2).

(1) A 2 cm square adhesive tape is attached to a 10 cm square smooth aluminum plate having a thickness of 9 mm at 23° C. and allowed to stand at 23° C. for 24 hours to form a specimen.

(2) Next, the center of the surface of the adhesive tape is compressed at a rate of 0.5 m/min with a force of 5 N/cm² to determine a displacement by using a tensile tester provided with a stainless probe having a diameter of 7 mm. The displacement represents the distance between a reference surface which is the smooth surface of the adhesive tape before the compression and the maximum depth of pushing in the thickness direction.

The thickness of the adhesive tape of the present invention may be properly adjusted according to the configuration used but is preferably 60 μm to 500 μm. In particular, in use for fixing the touch panel device and the casing, a thinner adhesive tape is required, and thus the thickness of the adhesive tape is preferably 80 μm to 400 μm and more preferably 100 μm to 350 μm.

Also, the adhesive tape of the present invention preferably has a peak value of loss tangent (tan δ) at a frequency of 1 Hz of 0.36 or more and more preferably 0.40 to 1.50. When the adhesive tape has a peak value of loss tangent within the range, the good touch feedback characteristic can be easily imparted.

The loss tangent (tan δ) at a frequency of 1 Hz can be determined according to the equation tan δ=G″/G′ using the storage elastic modulus (G′) and loss elastic modulus (G″) obtained by temperature dispersion measurement of dynamic viscoelasticity. In the measurement of dynamic viscoelasticity, a specimen formed by processing the adhesive tape into a circle with a diameter of 8 mm is held between parallel disks having a diameter of 8 mm in a measurement portion of the viscoelasticity tester used (manufactured by TA Instruments Japan Inc., trade name: ARES G2), and the loss tangent (tan δ) is measured from −50° C. to 150° C. at a heating rate of 2° C./min and a frequency of 1 Hz to determine a maximum value. When there are two or more maximum values, a larger value is used.

The adhesive tape of the present invention preferably has a face adhesive strength of 90 N/4 cm² or more and more preferably 130 N/4 cm² or more measured under measurement conditions described below.

The measurement conditions of the face adhesive strength are as described below in (3) to (5).

(3) Two double-sided adhesive tapes having a width of 5 mm and a length of 4 cm are parallel attached to a 5 cm square acryl plate having a thickness of 2 mm at 23° C.

(4) Next, the acryl plate with the double-sided tapes formed in (3) is attached to a rectangular smooth acrylonitrile-butadiene-styrene plate (ABS plate) having a thickness of 2 mm, a width of 10 cm, and a length of 15 cm and having a hole with a diameter of 1 cm provided at the center so that the center of the acryl plate coincides with the center of the ABS plate. Then, the plates are pressed by one reciprocation of a 2 kg roller and then allowed to stand at 23° C. for 1 hour to form a specimen.

(5) The acryl plate is pushed from the ABS plate constituting the specimen through the hole of the ABS plate using a tensile tester provided with a stainless probe having a diameter of 7 mm, and strength is measured when the ABS plate is separated from the acryl plate.

The adhesive tape of the present invention can be produced by laminating the foam substrate and the adhesive layer.

### [Foam Substrate]

The foam substrate constitutes the foam substrate layer of the adhesive tape.

The foam substrate having a thickness of 350 μm or less is preferably used, the foam substrate having a thickness of 50 μm to 300 μm is more preferably used, and the foam substrate having a thickness of 100 μm to 250 μm is still more preferably used.

When the adhesive tape having two or more foam substrate layers is produced, the total thickness of the foam substrate layers is preferably 350 μm or less, more preferably 50 μm to 300 μm, and still more preferably 100 μm to 250 μm because both the thinning of the adhesive tape and the suitable touch feedback characteristic can be satisfied.

From the viewpoint of easily adjusting the compressive displacement of the adhesive tape within a suitable range and satisfying the suitable touch feedback characteristic, excellent impact resistance, and excellent adhesion to an adherend, the foam substrate used preferably has an apparent density within a range of 0.10 g/cm³ to 0.70 g/cm³, more preferably has an apparent density within a range of 0.13 g/cm³ to 0.67 g/cm³, and particularly preferably has an apparent density within a range of 0.13 g/cm³ to 0.57 g/cm³. The upper limit of the apparent density is preferably 0.52 g/cm³, more preferably 0.48 g/cm³, and still more preferably 0.42 g/cm³. The apparent density represents a value calculated from the measured mass of about 1 cm³ of a foam substrate cut into a rectangle of 4 cm×5 cm.

The 25% compressive strength of the foam substrate is preferably 10 kPa to 1500 kPa, more preferably 20 kPa to 1000 kPa, still more preferably 20 kPa to 800 kPa, and particularly preferably 30 kPa to 700 kPa. The 25% compressive strength is preferably 20 kPa to 600 kPa because the adhesive tape satisfying both the more preferred touch feedback characteristic and followability to irregularities of an adherend surface can be produced. The upper limit of the 25% compressive strength is preferably 500 kPa and more preferably 450 kPa.

The 25% compressive strength represents the strength measured by compressing a specimen by about 0.25 mm (25% of the initial thickness) at a rate of 10 mm/min at 23° C., the specimen being formed by cutting the foam substrate into a 25 mm square and stacking the foam substrate squares up to a thickness of about 1 mm and being held between stainless plates larger than the specimen.

The foam substrate used preferably has an average bubble diameter in each of the flow direction and the width direction which is adjusted within a range of 10 μm to 700 μm, more preferably has an average bubble diameter adjusted within a range of 30 μm to 500 μm, and still more preferably has an average bubble diameter adjusted within a range of 50 μm to 400 μm because the compressive displacement of the adhesive tape can be easily adjusted within a suitable range.

A ratio (the average bubble diameter in the flow direction/the average bubble diameter in the width direction) between the average bubble diameters in the flow direction and the width direction is not particularly limited but is preferably 0.25 to 4 times, more preferably 0.33 to 3 times, still more preferably 0.5 to 2.3 times, and particularly preferably 0.7 to 1.3 times. With the ratio within the range described above, variation little occurs in flexibility and tensile strength of the foam substrate in the flow direction and the width direction, and the displacement during compression of the adhesive tape with a load of 5 N/cm² in the thickness direction can be preferably easily adjusted 12 μm or more and less than 130 μm.

The average bubble diameter in the thickness direction of the foam substrate is preferably 10 μm to 150 μm and more preferably 15 μm to 100 μm. With the average bubble diameter in the thickness direction within the range, suitable followability and cushion properties can be realized, and excellent adhesion can be easily realized in bonding between rigid bodies. Also, the average bubble diameter in the thickness direction is ½ or less and preferably ⅓ or less the thickness of the foam substrate because the density and strength of the foam substrate are easily secured. In addition, even when the displacement during compression of the adhesive tape with a load of 5 N/cm² in the thickness direction is 12 μm or more and less than 130 μm, desired strength can be easily secured.

A ratio (the average bubble diameter in the flow direction/the average bubble diameter in the thickness direction) of the average bubble diameter in the flow direction to that in the thickness direction of the foam substrate and a ratio (the average bubble diameter in the width direction/the average bubble diameter in the thickness direction) of the average bubble diameter in the width direction to that in the thickness direction of the foam substrate are both preferably 1 to 15, more preferably 1.5 to 10, and still more preferably 2 to 8. This ratio makes it easy to improve durability to interlayer breakage of a foam under dropping impact, easy to secure the suitable followability in the thickness direction and the cushion properties, and easy to realize good adhesion in bonding rigid bodies without causing a gap in which water and dust enter. Also, the displacement during compression of the resultant adhesive tape with a load of 5 N/cm² in the thickness direction can be easily adjusted to 12 μm or more and less than 130 μm.

The average bubble diameters of the foam substrate in the width direction, the flow direction, and the thickness direction are measured according to procedures described below.

First, the foam substrate is cut in a size of about 1 cm in the width direction and about 1 cm in the flow direction to prepare 10 specimens.

Next, a section of each of the 10 specimens is photographed within any range (a range of 1.5 mm in the flow direction and the whole length in the thickness direction) and region (a region of 1.5 mm in the width direction and the whole length in the thickness direction) using a digital microscope (trade name “KH-7700” manufactured by HiROX Co., Ltd., magnification of 200 times).

On the basis of the photographed image, the bubble diameters (diameters in the flow direction) of all bubbles present within the range (a region of 1.5 mm in the flow direction and the whole length in the thickness direction) of each of the 10 specimens are measured, and an average thereof is regarded as the average bubble diameter in the flow direction.

On the basis of the photographed image, the bubble diameters (diameters in the width direction) of all bubbles present within the range (a region of 1.5 mm in the width direction and the whole length in the thickness direction) of each of the 10 specimens are measured, and an average thereof is regarded as the average bubble diameter in the width direction.

On the basis of the photographed image, the bubble diameters (diameters in the thickness direction) of all bubbles present within the range (a region of 1.5 mm in the width direction and the whole length in the thickness direction) of each of the 10 specimens are measured, and an average thereof is regarded as the average bubble diameter in the thickness direction.

The foam substrate used in the present invention preferably has an independent bubble structure as a bubble structure because water intrusion and dust from a cross-section of the foam substrate can be effectively prevented. The bubbles which form the independent bubble structure are preferably independent bubbles having a shape in which the average bubble length in the flow direction or the width direction or the average bubble lengths in both directions of the foam are longer than the average bubble length in the thickness direction because the foam has proper followability and cushion properties.

In the foam substrate used in the present invention, the tensile strength in each of the flow direction and the width direction is not particularly limited but is preferably 150 N/cm² or more, more preferably 150 N/cm² to 2000 N/cm², and still more preferably 150 N/cm² to 1700 N/cm². The tensile elongation at break in a tensile test is not particularly limited but the tensile elongation in the flow direction is preferably 100% or more, more preferably 100% to 1200%, still more preferably 200% to 1000%, and particularly preferably 200% to 600%. The foam substrate having the tensile strength and tensile elongation within the respective ranges described above can suppress deterioration in processability of the adhesive tape and decrease in attaching workability even when being a foamed flexible substrate.

The tensile strength of the foam substrate in each of the flow direction and the width direction represents the maximum strength obtained by measuring a sample having a reference line length of 2 cm and a width of 1 cm using a Tension tensile tester under the measurement condition of a tensile speed of 300 mm/min in an environment of 23° C. and 50% RH.

The compressive strength, apparent density, interlayer strength, and tensile strength of the foam substrate can be properly adjusted according to the material and foam structure of the substrate used.

Examples of the foam substrate which can be used include polyolefin foams produced by using polyolefins such as polyethylene, polypropylene, ethylene-propylene copolymers, ethylene-vinyl acetate copolymers, and the like, polyurethane foams, acrylic foams, other rubber foams, and the like.

Among these foams described above, the polyolefin foams can be preferably used because the displacement of the adhesive tape during compression with a load of 5 N/cm² in the thickness direction can be easily adjusted to 12 μm or less and less than 130 μm, and a thin foam substrate having an independent bubble structure with excellent followability to surface irregularities of an adherend and excellent cushion absorption can be easily produced.

Of the polyolefin foams using polyolefin resins, a polyethylene resin or polypropylene resin is preferably used because the foam can be easily produced with a uniform thickness and easily imparted with suitable flexibility. In particular, the polyethylene resin is preferably used, and the content of the polyethylene resin in the polyolefin resin is preferably 40% by mass or more, more preferably 50% by mass or more, still more preferably 60% by mass or more, and particularly preferably 100% by mass.

Examples of the polyethylene resin which can be used for producing the polyolefin foam include linear low-density polyethylene, low-density polyethylene, medium-density polyethylene, high-density polyethylene, an ethylene-α-olefin copolymer containing 50% by weight or more of ethylene, an ethylene-vinyl acetate copolymer containing 50% by weight or more of ethylene, and the like. These can be used alone or in combination of two or more.

Examples of α-olefin constituting the ethylene-α-olefin copolymer include propylene, 1-butene, 1-pentene, 4-methyl-1-pentene, 1-hexene, 1-heptene, 1-octene, and the like.

Examples of the polypropylene resin include, but are not particularly limited to, polypropylene, a propylene-α-olefin copolymer containing 50% by weight or more of propylene, and the like. These may be used alone or in combination of two or more. Examples of α-olefin constituting the propylene-α-olefin copolymer include ethylene, 1-butene, 1-pentene, 4-methyl-1-pentene, 1-hexene, 1-heptene, 1-octene, and the like.

It is particularly preferred to use as the polyethylene resin a polyethylene resin having a narrow molecular weight distribution and produced by using a metallocene compound containing a tetravalent transition metal as a polymerization catalyst. Even when the polyethylene resin produced by the method has any molecular weight, the copolymerization ratio of a copolymerized component can be adjusted to be substantially the same, resulting in the polyolefin foam substantially uniformly crosslinked. The polyolefin foam substantially uniformly crosslinked is easily elongated and the thickness thereof is easily made uniform as a whole.

The polyolefin foam may have a crosslinked structure, but when the polyolefin foam is produced by foaming a polyolefin resin sheet with a thermal decomposition-type foaming agent, the foam is preferably designed to form a crosslinked structure. The degree of crosslinking is preferably within a range of 5% by mass to 60% by mass and more preferably within a range of 10% by mass to 55% by mass in view of further improving the adhesion to the adhesive layer (B), the touch feedback characteristics, and the impact resistance.

The degree of crosslinking is measured as follows. First, a set of 5 foam substrates of 40 mm×50 mm square is prepared as a sample, and the total mass (G1) thereof is measured. Next, the sample is immersed in xylene at 120° C. for 24 hours, a xylene insoluble substance is separated by filtration with a 300-mesh wire net and then dried at 100° C. for 1 hour, and then the mass (G2) of the residue is measured. The xylene insoluble content determined by an equation below is regarded as the degree of crosslinking.

Degree of crosslinking (% by mass)=(G2/G1)×100

A method for producing the polyolefin foam is not particularly limited, and for example, the method includes a step of producing a foamable polyolefin resin sheet by supplying, to an extruder, a foamable polyolefin resin composition containing a polyolefin resin, which contains 40% by weight or more of polyethylene resin produced by using as a polymerization catalyst a metallocene compound containing a tetravalent transition metal, a thermal decomposition-type foaming agent, a foaming aid, and a colorant for coloring the foam in black, white, or the like, melt-kneading the resultant mixture, and then extruding in a sheet shape from the extruder; a step of crosslinking the foamable polyolefin resin sheet; a step of foaming the foamable polyolefin resin sheet; and a step of melting or softening the resultant foamed sheet and stretching the foamed sheet by stretching in any one or both of the flow direction and the width direction. The step of stretching the foamed sheet may be performed as occasion demands and may be performed in several times.

The thermal decomposition-type foaming agent is not particularly limited as long as it has been used for producing foams, and examples thereof include azodicarbonamide, N,N′-dinitrosopentamethylenetetramine, p-toluenesulfonyl semicarbazide, hydrazodicarbonamide, p,p′-oxybisbenzenesulfonylhydrazide, and the like. Among these, azodicarbonamide is preferred. The thermal decomposition-type foaming agents may be use alone or in combination of two or more.

The amount of the thermal decomposition-type foaming agent added may be properly determined according to the foaming magnification of the polyolefin foam but is preferably 1 part by mass to 40 parts by mass relative to 100 parts by mass of the polyolefin resin because the foaming magnification can be easily adjusted to a desired value, tensile strength can be adjusted to desired strength, and a displacement of the resultant adhesive tape during compression with a load of 5 N/cm² in the thickness direction can be adjusted to 12 μm or more and less than 130 μm.

The foam substrate may be colored for expressing a design, light-spieling and concealment properties, light reflectivity, and light resistance in the adhesive tape. A single coloring agent can be used or combination of a plurality of types may be used.

When the light-shielding and concealment properties and light resistance are imparted to the adhesive tape, the foam substrate is colored in black. Examples of a black coloring agent which can be used include carbon black, graphite, copper oxide, manganese dioxide, aniline black, perylene black, titanium black, cyanine black, activated carbon, ferrite, magnetite, chromium oxide, iron oxide, molybdenum disulfide, chromium complexes, composite oxide-based black dyes, anthraquinone-based organic black dyes, and the like. In particular, carbon black is preferred from the viewpoint of cost, availability, insulation, and heat resistance to the temperature in the step of extruding the foamable polyolefin resin composition and in the heat-foaming step.

When the design and light reflectivity are imparted to the adhesive tape, the foam substrate is colored in white. Examples of a white coloring agent which can be used include inorganic white coloring agents such as titanium oxide, zinc oxide, aluminum oxide, silicon oxide, magnesium oxide, zirconium oxide, calcium oxide, tin oxide, barium oxide, cesium oxide, yttrium oxide, magnesium carbonate, calcium carbonate, barium carbonate, zinc carbonate, aluminum hydroxide, magnesium hydroxide, calcium hydroxide, zinc hydroxide, aluminum silicate, calcium silicate, barium sulfate, calcium sulfate, barium stearate, zin flower, talc, silica, alumina, cray, kaolin, titanium phosphate, mica, gypsum, white carbon, diatomaceous earth, bentonite, Lithopone, zeolite, sericite, and the like; organic while coloring agents such as silicone-based resin particles, acrylic resin particles, urethane-based resin particles, melamine-based resin particles, and the like. Among these, titanium oxide, aluminum oxide, and zinc oxide are preferred from the viewpoint of cost, cost, availability, color tone, and heat resistance to the temperature in the step of extruding the foamable polyolefin resin composition and in the heat-foaming step.

If required, the foam substrate may contain known materials such as a plasticizer, an antioxidant, a foaming aid such as zinc oxide, a bubble nucleus regulator, a thermal stabilizer, a flame retardant such as aluminum hydroxide, magnesium hydroxide, or the like, an antistatic agent, a filler such as glass or plastic hollow balloons/beads, a metal powder, a metal compound, or the like, a conductive filler, a thermally conductive filler, and the like.

When the coloring agent, the thermal decomposition-type foaming agent, and the foaming aid are mixed with the foamable polyolefin resin composition, from the viewpoint of preventing an appearance defect such as color density unevenness, a foaming defect such as excessive foaming, no foaming, or the like, a master butch is preferably prepared by using the foamable polyolefin resin composition and a thermoplastic resin highly compatible with the foamable polyolefin resin composition before supply to the extruder.

Examples of a method for crosslinking the polyolefin resin foam substrate include a method of irradiating the foamable polyolefin resin sheet with an ionizing radiation, a method of mixing the foamable olefin-based resin composition with an organic peroxide and then decomposing the organic peroxide by heating the resultant foamable polyolefin resin sheet, and the like. These method may be used in combination.

Examples of the ionizing radiation include an electron beam, α-ray, β-ray, γ-ray, and the like. The quantity of the ionizing radiation is properly adjusted so that the degree of crosslinking of the polyolefin resin foam substrate is in the suitable range described above, but is preferably in a range of 5 to 200 kGy. In addition, both surfaces of the foamable polyolefin resin sheet are preferably irradiated with the ionizing irradiation because a uniform foaming state can be easily obtained, and both surfaces are more preferably irradiated in the same quantity of radiation.

Examples of the organic peroxide include 1,1-bis(tert-butylperoxy)-3,3,5-trimethylcyclohexane, 1,1-bis(tert-butylperoxy)cyclohexane, 2,2-bis(tert-butylperoxy)octane, n-butyl-4,4-bis(tert-butylperoxy)valerate, di-tert-butyl peroxide, tert-butylcumyl peroxide, dicumyl peroxide, α,α′-bis(tert-butylperoxy-m-isopropyl)benzene, 2,5-dimethyl-2,5-di(tert-butylperoxy)hexane, 2,5-dimethyl-2,5-di(tert-butylperoxy)hexyne-3, benzoyl peroxide, cumylperoxy neodecanate, tert-butylperoxy benzoate, 2,5-dimethyl-2,5-di(benzoylperoxy)hexane, tert-butylperoxyisopropyl carbonate, tert-butylperoxyally carbonate, and the like. These may be used alone or in combination of two or more.

The amount of the organic peroxide added is preferably in a range of 0.01 parts by mass to 5 parts by mass and more preferably in a range of 0.1 parts by mass to 3 parts by mass relative to 100 parts by mass of the polyolefin resin because remaining of a decomposition residue of the organic peroxide is suppressed and a displacement of the resultant adhesive tape in compression with a load of 5 N/cm² in the thickness direction can be adjusted to 12 μm or more and less than 130 μm.

Examples of a method for foaming the foamable polyolefin resin sheet include, but are not particularly limited to, a method of heating with hot air, a method heating with infrared light, a salt-bath method, an oil-bath method, and the like. These methods may be used in combination. Among these methods, the method of heating with hot air and the method of heating with infrared light are preferred because of little difference in appearance between the front and back surfaces of the polyolefin foam.

The foam substrate may be stretched after the foam substrate is produced by foaming the foamable polyolefin resin sheet or during foaming of the foamable polyolefin resin sheet. When the foam substrate may be stretched after the foam substrate is produced by foaming the foamable polyolefin resin sheet, the foam substrate may be stretched continuously while a melt state during foaming is maintained without cooling the foam substrate or may be stretched in a melt or softened state caused by again heating the foamed sheet after cooling the foam substrate.

The melt state of the foam substrate represents a state in which the foam substrate is heated, on both surface, to a temperature equal to or higher than the melting point of the polyolefin resin constituting the foam substrate. The softening of the foam substrate represents a state in which the foam substrate is heated, on both surfaces, to a temperature lower than the melting point temperature of the polyolefin resin constituting the foam substrate. Stretching the foam substrate can stretch and deform the bubbles in the foam substrate in a predetermined direction, thereby producing the polyolefin foam having a bubble aspect ratio within a predetermined range.

Further, with respect to the stretching direction of the foam substrate, the long foamable polyolefin resin sheet is stretched in the flow direction or the width direction or in the flow direction and the width direction. When the foam substrate is stretched in the flow direction and the width direction, the foam substrate may be stretched simultaneously in the flow direction and the width direction or stretched separately in each of the flow direction and the width direction.

Examples of a method for stretching the foam substrate in the flow direction include a method of stretching the foam substrate in the flow direction by taking-up, under cooling after foaming, the long foamed sheet at a speed (take-up speed) higher than a speed (feed speed) at which the long foamable polyolefin resin sheet is supplied to the foaming step, a method of stretching the foam substrate in the flow direction by taking-up the foam substrate at a speed (take-up speed) higher than a speed (feed speed) at which the resultant foam substrate is supplied to the stretching step, and the like.

In the former method, the foamable polyolefin resin sheet easily expands due to its own foaming in the flow direction, and thus when the foam substrate is stretched in the flow direction, the feed speed and the take-up speed of the foam substrate are preferably adjusted in consideration of the expansion due to foaming of the foamable polyolefin resin sheet in the flow direction so that the foam substrate is stretched in an amount larger than the expansion in the flow direction.

A preferred method for stretching the foam substrate in the width direction includes gripping both ends of the foam substrate in the width direction with a pair of gripping members and gradually moving the pair of gripping members in a direction of separating from each other to stretch the foam substrate in the width direction. In addition, the foamable polyolefin resin sheet expands due to its own foaming in the width direction, and thus when the foam substrate is stretched in the width direction, stretching is preferably adjusted in consideration of the expansion due to foaming of the foamable polyolefin resin sheet in the width direction so that the foam substrate is stretched in an amount larger than the expansion in the width direction.

The stretch magnification of the polyolefin foam in the flow direction is preferably 1.1 to 5 times and more preferably 1.3 to 3.5 times.

The stretch magnification of the polyolefin foam in the width direction is preferably 1.2 to 4.5 times and more preferably 1.5 to 3.5 times.

The foam substrate may be surface-treated by corona treatment, flame treatment, plasma treatment, hot-air treatment, ozone/ultraviolet treatment, coating with an easy adhesion treatment agent, or the like for improving the adhesion to the adhesive layer and other layers. The surface treatment is performed so that a wetting index with a wetting reagent is 36 mN/m or more, preferably 40 mN/m, and more preferably 48 mN/m because good adhesion to the adhesive can be obtained. The foam substrate with the improved adhesion may be bonded to the adhesive layer in a continuous process or may be temporarily taken up. When the foam substrate is temporarily taken up, the foam substrate is preferably taken up together with interleaving paper such as paper or a polyethylene, polypropylene, or polyester film in order to prevent a blocking phenomenon between the foam substrates having improved adhesion, and a polypropylene film or polyester film having a thickness of 25 μm or less is preferred.

### [Adhesive Layer]

An adhesive composition which is used for usual adhesive tapes can be used as an adhesive composition constituting the adhesive layer of the adhesive tape of the present invention.

Examples of the adhesive composition include a (meth)acrylic adhesive, a urethane-based adhesive, a synthetic rubber-based adhesive, a natural rubber-based adhesive, a silicone-based adhesive, and the like, and a (meth)acrylic adhesive composition containing an acrylic polymer produced by polymerizing monomers containing (meth)acrylate, and if required, additives such as a tackifier resin, a crosslinking agent, and the like can be preferably used.

Examples of (meth)acrylate constituting the (meth)acrylic polymer include (meth)acrylates each having an alkyl group having 1 to 12 carbon atoms, such as methyl (meth)acrylate, ethyl (meth)acrylate, n-butyl (meth)acrylate, isobutyl (meth)acrylate, tert-butyl (meth)acrylate, n-hexyl (meth)acrylate, n-octyl (meth)acrylate, isooctyl (meth)acrylate, isononyl (meth)acrylate, cyclohexyl (meth)acrylate, 2-ethylhexyl (meth)acrylate, decyl (meth)acrylate, lauryl (meth)acrylate, and the like. These can be used alone or in combination of two or more. In particular, (meth)acrylates each having an alkyl group having 4 to 12 carbon atoms are preferably used, and (meth)acrylates each having a linear or branched alkyl group having 4 to 8 carbon atoms are more preferably used. In particular, n-butyl acrylate is preferred for securing adhesion to the adherend and achieving the adhesive with excellent cohesive force and sebum resistance.

The (meth)acrylate is preferably used within a range of 80% by mass to 98.5% by mass and more preferably within a range of 90% by mass to 98.5% by mass relative to the total amount of monomer used for producing the acrylic polymer.

In addition, in producing the acrylic polymer used in the present invention, a polar vinyl monomer can be used as the monomer. Examples of the polar vinyl monomer include a hydroxyl group-containing vinyl monomer, a carboxyl group-containing vinyl monomer, and an amide group-containing vinyl monomer, and these can be used alone or in combination of two or more.

Examples of the hydroxyl group-containing vinyl monomer which can be used include (meth)acrylate having a hydroxyl group, such as 2-hydroxyethyl (meth)acrylate, 2-hydroxypropyl (meth)acrylate, 4-hydroxybutyl (meth)acrylate, 6-hydroxyhexyl (meth)acrylate, and the like.

Examples of the carboxyl group-containing vinyl monomer which can be used include acrylic acid, methacrylic acid, itaconic acid, maleic acid, (meth)acrylic acid dimer, chrotonic acid, ethylene oxide-modified succinic acid acrylate, and the like. In particular, acrylic acid is preferably used.

Examples of the amide group-containing vinyl monomer which can be used include N-vinylpyrrolidone, N-vinylcaprolactam, (meth)acryloylmorpholine, acrylamide, N,N-dimethyl (meth)acrylamide, and the like.

Example of other polar vinyl monomers which can be used include vinyl acetate, sulfonic acid group-containing monomers such as 2-acrylamide-2-methylpropane sulfonic acid and the like, and the like.

The polar vinyl monomer is preferably used within a range of 1.5% by mass to 20% by mass, more preferably within a range of 1.5% by mass to 10% by mass, and still more preferably within a range of 2% by mass to 8% by mass relative to the total amount of monomer used for producing the acrylic polymer. At the content within the range, the cohesive force, retention force, and adhesion of the adhesive can be easily adjusted within respective suitable ranges.

When an isocyanate-based crosslinking agent is used as the crosslinking agent, a vinyl monomer having a hydroxyl group is preferred as a vinyl monomer having a functional group reactive with the crosslinking agent, and 2-hydroxyethyl (meth)acrylate, 4-hydroxybutyl (meth)acrylate, and 6-hydroxyhexyl (meth)acrylate are particularly preferred. The vinyl monomer having a hydroxyl group reactive with the isocyanate-based crosslinking agent is preferably used within a range of 0.01% by mass to 1.0% by mass and more preferably within a range of 0.03% by mass to 0.3% by mass relative to the total amount of monomer used for producing the acrylic polymer.

The acrylic polymer can be produced by a known polymerization method such as a solution polymerization method, a bulk polymerization method, a suspension polymerization method, an emulsion polymerization method, or the like. The acrylic polymer is preferably produced by the solution polymerization method or bulk polymerization method for further improving the moisture resistance of the adhesive.

A method for initiating the polymerization is, for example, a method using a polymerization initiator. Examples of the polymerization initiator which can be used include peroxide-based polymerization initiators such as benzoyl peroxide, lauroyl peroxide, and the like; azo-based thermopolymerization initiators such as azobisisobutyronitrile and the like; acetophenone-based photopolymerization initiators; benzoin ether-based photopolymerization initiators; benzylketal-based photopolymerization initiators; acylphosphine oxide-based photopolymerization initiators; benzoin-based photopolymerization initiators; and benzophenone-based photopolymerization initiators.

The weight-average molecular weight of the acrylic polymer is 400,000 to 3,000,000 and preferably 800,000 to 2,500,000 measured by gel permeation chromatography (GPC) in terms of standard polystyrene.

The molecular weight is measured by the GPC method using a GPC apparatus (HLC-8320GPC) manufactured by Tosoh Corporation in terms of standard polystyrene under measurement conditions below.

Sample concentration: 0.5% by mass (tetrahydrofuran solution)

Sample injection amount: 100 μl

Eluent: THF (tetrahydrofuran)

Flow rate: 1.0 ml/min

Measurement temperature: 40° C.

Main column: TSK gel GMHHR-H (20) 2 columns

Guard column: TSK gel HXL-H

Detector: Differential diffractometer

Standard polystyrene molecular weight: 10,000 to 20,000,000 (manufactured by Tosoh Corporation)

For the purpose of further improving the adhesion and face adhesive strength to an adherend, a tackifier resin is preferably used for the adhesive composition used for forming the adhesive layer.

Examples of the tackifier resin which can be used include rosin-based tackifier resins, polymerized rosin-based tackifier resins, polymerized rosin ester-based tackifier resins, rosin phenol-based tackifier resins, stabilized rosin ester-based tackifier resins, disproportionated rosin ester-based tackifier resins, hydrogenated rosin ester-based tackifier resins, terpene-based tackifier resins, terpenephenol-based tackifier resins, petroleum resin-based tackifier resins, (meth)acrylate-based tackifier resins, and the like. When an emulsion-type adhesive composition is used as the adhesive composition, an emulsion-type tackifier resin is preferably used.

Among the tackifier resins described above, one or two or more of the disproportionated rosin ester-based tackifier resins, polymerized rosin ester-based tackifier resins, rosin phenol-based tackifier resins, hydrogenated rosin ester-based tackifier resins, (meth)acrylate-based tackifier resins, terpene-based tackifier resins are preferably used as the tackifier resin.

The softening point of the tackifier resin is not particularly limited but is 30° C. to 180° C. and preferably 70° C. to 140° C. The high adhesive performance can be expected by mixing the tackifier resin having a high softening point. In the case of a (meth)acrylate-based tackifier resin, the glass transition temperature is 30° C. to 200° C. and preferably 50° to 160° C.

The amount of the tackifier resin used is preferably 1 part by mass to 65 parts by mass and more preferably 4 parts by mass to 55 parts by mass relative to 100 parts by mass of the acrylic polymer. By using the adhesive composition containing the tackifier resin within the range, the adhesion to the adherend can be further improved.

The adhesive composition is preferably used in combination with the crosslinking agent for the purpose of further improving the cohesive force of the adhesive layer.

Examples of the crosslinking agent which can be used include an isocyanate-based crosslinking agent, an epoxy-based crosslinking agent, a metal chelate-based crosslinking agent, an aziridine-based crosslinking agent, and the like. Among these, a crosslinking agent of a type that can be added after polymerization of the acrylic polymer and allows a crosslinking reaction to proceed is preferably used. The isocyanate-based crosslinking agent and the epoxy-based crosslinking agent which are rich in reactivity with the (meth)acrylic polymer are preferably used, and the isocyanate-based crosslinking agent is more preferably used for further improving the adhesion to the foam substrate.

Examples of the isocyanate-based crosslinking agent which can be used include tolylene diisocyanate, naphthylene-1,5-diisocyanate, hexamethylene diisocyanate, diphenylmethane diisocyanate, xylylene diisocyanate, trimethylolpropane-modified tolylene diisocyanate, and the like, and a polyisocyanate having three isocyanate groups is preferably used. Examples of the polyisocyanate having three isocyanate groups which can be used include tolylene isocyanate trimethylolpropane adduct, triphenylmethane isocyanate, and the like.

A value of gel fraction obtained by measuring an insoluble content after the adhesive layer is immersed in toluene for 24 hours is used as an index of the degree of cross-linkage of the adhesive layer. The gel fraction is preferably within a range of 25% by mass to 70% by mass. When the gel fraction is more preferably 30% by mass to 60% by mass and still more preferably 30% by mass to 55% by mass, both the cohesion and adhesion are good.

The gel fraction is measured by a method described below.

First, the adhesive containing the adhesive composition and, if required, the crosslinking agent is applied to a release sheet so that the thickness after drying is 50 μm and dried at 100° C. for 3 minutes, followed by aging at 40° C. for 2 days. Then, the resultant sheet is cut into a 50 mm square used as a sample.

Next, the mass (G1) of the sample is measured, and then the sample is immersed in a toluene solution at 23° C. for 24 hours. After the immersion, the toluene insoluble content of the sample is separated by filtration though a 300-mesh wire net and dried at 110° C. for 1 hour, and then the mass (G2) of the residue is measured. The gel fraction is determined according to an equation below.

Gel fraction (% by mass)=(G2/G1)×100

If required, an additive such as a plasticizer, a softener, an antioxidant, a flame retardant, a filler such as glass or plastic fibers/balloons/beads, a metal powder, a metal oxide, a metal nitride, or the like, a coloring agent such as a pigment, a dye, or the like, a leveling agent, a thickener, a water repellent, a defoaming agent, or the like can be used for the adhesive.

The adhesive layer constituting the adhesive tape of the present invention preferably has a temperature of −40° C. to 15° C. as a temperature indicating a peak value of loss tangent (tan δ) at a frequency of 1 Hz. The adhesive layer having a loss tangent peak value within the range can easily impart the good adhesion to the adherend at room temperature. In particular, in order to improve dropping-impact resistance in a low-temperature environment, the peak value is preferably −35° C. to 10° C. and more preferably −30° C. to 6° C.

The loss tangent (tan δ) at a frequency of 1 Hz can be determined according to the equation tan δ=G″/G′ using the storage elastic modulus (G′) and loss elastic modulus (G″) obtained by temperature dispersion measurement of dynamic viscoelasticity. In the measurement of dynamic viscoelasticity, a specimen formed from the adhesive layer having a thickness of about 2 mm is held between parallel disks having a diameter of 8 mm in a measurement portion of the viscoelasticity tester used (manufactured by TA Instruments Japan Inc., trade name: ARES G2), and the storage elastic modulus (G′) and loss elastic modulus (G″) are measured from −50° C. to 150° C. at a frequency of 1 Hz.

The thickness of the adhesive layer used in the present invention is preferably 10 μm to 150 μm and more preferably 20 μm to 100 μm because the adhesion to the adherend and vibration properties can be easily secured.

The adhesive tape of the present invention produced by the method described above has the adhesive layer on at least one, preferably both, of the surfaces of the foam substrate, and thus when used for fixing the touch panel device having the tactile feedback function and the casing, the suitable touch feedback characteristic can be imparted. Therefore, the adhesive tape can be preferably used for fixing the casing and the touch panel device of a portable electronic apparatus, such as a smartphone, a tablet-type computer, or the like, which is highly required to be improved in operability.

Also, dropping impact can be absorbed by the foam, and thus the adhesive tape can be preferably applied for fixing a touch panel device having a diagonal of 3.5 inches or more, particularly for fixing a touch panel device having a large mass per unit adhesion area. Further, using the foam substrate and the adhesive layer can exhibit good adhesion and followability to the adherend and effectively prevent water intrusion and dust entering from an adhesion gap, and thus the adhesive tape has excellent water-proof and droplet-proof/dust-proof function.

According to an embodiment of the present invention, the adhesive tape has a basic configuration including the foam substrate as a core and the adhesive layer provided on at least one, preferably both, of the surface of the substrate. The adhesive layer may be laminated directly on the foam substrate, or another layer may be provided therebetween. The configuration may be properly selected according to use application, and there may be provided a laminate layer such as a polyester film for further imparting dimensional stability, tensile strength, and reworkability to the adhesive tape, a light-shielding layer for imparting the light-shielding property to the tape, a light-reflecting layer for securing light reflectivity, a metal foil, a metal mesh, or a nonwoven fabric plated with a conductive metal for imparting an electromagnetic wave-spieling property and plane-direction thermal conductivity, or two or more foam substrate layers for adjusting the vibration properties and thickness of the adhesive tape.

Examples of the laminate layer which can be used include various resin films such as a polyester film such as polyethylene terephthalate, a polyethylene film, a polypropylene film, and the like. The thickness of the film is not particularly limited but is preferably 1 to 25 μm and more preferably 2 to 12 μm in view of followability of the foam substrate. A transparent film, a light-spieling film, a reflective film can be used as the laminate layer according to the purpose. When the foam layer and the laminate layer are laminated, a usual known adhesive or an adhesive for dry lamination can be used. Further, a color for discriminating the laminate layer or an antistatic agent may be added to the sensitive adhesive or bonding agent.

When two or more foam substrate layers are provided, the foam substrates of the layers may be the same or different from each other. However, a single-layer foam substrate can be preferably used because the number of tape production steps can be decreased, the cost can be easily decreased, and the compressive displacement can be easily adjusted.

The light-shielding layer formed using an ink containing a coloring agent such as a pigment can be simply used, and a layer composed of black ink is preferably used because of excellent light-shielding property. A layer composed of white ink can be simply used as the reflecting layer. The thickness of each of these layers is preferably 2 μm to 20 μm and more preferably 3 μm to 6 μm. With the thickness within the range, the substrate is little curled due to curing shrinkage of the ink used, and thus processability of the tape is improved.

The adhesive tape of the present invention can be produced by a known common method. Examples of the method include a direct method in which the adhesive composition is applied directly on the foam substrate or on a surface of another layer laminated on the foam substrate and is then dried, and a transfer method in which the adhesive composition is applied to a release sheet, dried, and then transferred to the foam substrate or a surface of another layer. When the adhesive layer is formed by drying a mixture prepared by mixing the acrylic adhesive composition and the crosslinking agent, after the adhesive tape is formed, an aging step is preferably performed for 2 to 7 days in an environment of 20° C. to 50° C., preferably 23° C. to 45° C., because the adhesion and adhesion physical properties between the foam substrate and the adhesive layer are stabilized.

Examples of the release sheet include, but are not particularly limited to, synthetic resin films such as polyethylene, polypropylene, and polyester films, and the like, paper, a nonwoven fabric, a cloth, a foam sheet, a metal foil, and a substrate such as a laminate at least one side of which is subjected to release treatment such as silicone treatment, long-chain alkyl treatment, fluorine treatment, or the like for enhancing releazability from the adhesive.

In particular, the release sheet is preferably fine paper on both sides of which polyethylene having a thickness of 10 μm to 40 μm is laminated, or a polyester film substrate which is subjected to addition reaction-type silicone release treatment on one or both sides.

The adhesive tape of the present invention having the configuration described above can preferably impart tactile feedback when a touch panel device having the touch feedback characteristic, particularly a touch panel provided with a vibration source for giving the touch feedback characteristic, is fixed to a casing, and thus the adhesive tape can be used for various electronic devices having the touch panel function. Therefore, the adhesive tape can be preferably used for portable electronic devices which are highly requested to be improved in operability, such as a smartphone, a tablet computer, a notebook computer, an electronic organizer, a cellular phone, PHS, a digital camera, a music player, a television, and a game machine. Examples of the information display device include a liquid crystal display (LCD), an organic EL display (OELD), a plasma display panel (PDP), an electronic paper, and the like.

Further, using the foam substrate and the adhesive layer can exhibit suitable adhesion and followability to the adherend, effectively prevent entering of a liquid, such as water, and dust and sand from an adhesion gap, and can impart excellent water-proof and droplet-proof/dust-proof function. Also, the adhesive tape can be preferably used for fixing a built-in battery, a speaker, a receiver, a piezoelectric element, a printed circuit board, a flexible printed circuit board (FPC), a digital camera module, sensors, other modules, polyurethane or polyolefin-based cushion material rubber members, decorative components, various members, etc.

### EXAMPLES

### (Preparation of Adhesive Composition (A))

In a reactor provided with a stirrer, a reflux condenser, a thermometer, a dropping funnel, and a nitrogen gas inlet, 93.8 parts by mass of n-butyl acrylate, 3.1 parts by mass of acrylic acid, 3 parts by mass of vinyl acetate, 0.1 parts by mass of 2-hydroxyethyl acrylate, and 0.1 parts by mass of 2,2′-azobisisobutyronitrile as a polymerization initiator were dissolved in a solvent containing 100 parts by mass of ethyl acetate and polymerized at 70° C. for 12 hours to produce a solvent solution of an acrylic copolymer (1) having a weight-average molecular weight of 1,600,000 (in terms of polystyrene).

Next, 9 parts by mass of “Super Ester A100” (manufactured by Arakawa Chemical Industries, Ltd., disproportionated rosin glycerin ester) and 10 parts by mass of “Haritack PCJ” (manufactured by Harima Chemicals Inc., polymerized rosin pentaerythritol ester) were added to 100 parts by mass of the acrylic copolymer (1), and ethyl acetate was added to the resultant mixture and uniformly mixed to prepare an adhesive composition (A) having a nonvolatile content of 38% by mass.

### (Preparation of Adhesive Composition (B))

In a reactor provided with a stirrer, a reflux condenser, a thermometer, a dropping funnel, and a nitrogen gas inlet, 97.95 parts by mass of n-butyl acrylate, 2.0 parts by mass of acrylic acid, 0.05 parts by mass of 4-hydroxybutyl acrylate, and 0.1 parts by mass of 2,2′-azobisisobutyronitrile as a polymerization initiator were dissolved in a solvent containing 100 parts by mass of ethyl acetate and polymerized at 70° C. for 12 hours to produce a solvent solution of an acrylic copolymer (2) having a weight-average molecular weight of 2,000,000 (in terms of polystyrene).

Next, 25 parts by mass of “Super Ester A100” (manufactured by Arakawa Chemical Industries, Ltd., disproportionated rosin glycerin ester), 5 parts by mass of “Pensel D135” (manufactured by Arakawa Chemical Industries, Ltd., polymerized rosin pentaerythritol ester), and 20 parts by mass of FTR6100 (manufactured by Mitsui Chemicals, Inc., styrene-based petroleum resin) were added to 100 parts by mass of the acrylic copolymer (2), and ethyl acetate was added to the resultant mixture and uniformly mixed to prepare an adhesive composition (B) having a nonvolatile content of 40% by mass.

### (Preparation of Adhesive Composition (C))

In a reactor provided with a stirrer, a reflux condenser, a thermometer, a dropping funnel, and a nitrogen gas inlet, 44.9 parts by mass of n-butyl acrylate, 50 parts by mass of 2-ethylhexyl acrylate, 3 parts by mass of vinyl acetate, 2 parts by mass of acrylic acid, 0.1 parts by mass of 4-hydroxybutyl acrylate, and 0.1 parts by mass of 2,2′-azobisisobutyronitrile as a polymerization initiator were dissolved in a solvent containing 100 parts by mass of ethyl acetate and polymerized at 70° C. for 12 hours to produce a solvent solution of an acrylic copolymer (3) having a weight-average molecular weight of 1,200,000 (in terms of polystyrene).

Next, 10 parts by mass of “Pensel D135” (manufactured by Arakawa Chemical Industries, Ltd., polymerized rosin pentaerythritol ester) was added to 100 parts by mass of the acrylic copolymer (3), and ethyl acetate was added to the resultant mixture and uniformly mixed to prepare an adhesive composition (C) having a nonvolatile content of 45% by mass.

### (Preparation of Adhesive Composition (D))

In a reactor provided with a stirrer, a reflux condenser, a thermometer, a dropping funnel, and a nitrogen gas inlet, 71.9 parts by mass of n-butyl acrylate, 20 parts by mass of 2-ethylhexyl acrylate, 5 parts by mass of acrylic acid, 3 parts by mass of methyl acrylate, 0.1 parts by mass of 2-hydroxyethyl acrylate, and 0.1 parts by mass of 2,2′-azobisisobutyronitrile as a polymerization initiator were dissolved in a solvent containing 100 parts by mass of ethyl acetate and polymerized at 70° C. for 12 hours to produce a solvent solution of an acrylic copolymer (4) having a weight-average molecular weight of 1,200,000 (in terms of polystyrene).

Next, 20 parts by mass of “Pensel D135” (manufactured by Arakawa Chemical Industries, Ltd., polymerized rosin pentaerythritol ester) and 10 parts by mass of T160 (manufactured by Yasuhara Chemical Co. Ltd., terpene phenol) were added to 100 parts by mass of the acrylic copolymer (4), and ethyl acetate was added to the resultant mixture and uniformly mixed to prepare an adhesive composition (D) having a nonvolatile content of 45% by mass.

### Example 1

### Formation of Double-Sided Adhesive Tape

To 100 parts by mass of the adhesive composition (A), 1.1 parts by mass of “Coronate L-45” (manufactured by Nippon Polyurethane Industry Co., Ltd., isocyanate-based crosslinking agent, solid content 45% by mass) was added and stirred for 15 minutes, and then the resultant mixture was applied to a release-treated surface of a release-treated polyethylene terephthalate film (PET film) having a thickness of 75 μm so that the thickness after drying was 75 μm and then dried at 80° C. for 3 minutes to form an adhesive layer.

The adhesive layer formed by allowing the adhesive layer to stand (aging) in an environment of 40° C. for 48 hours had a gel fraction of 48% by mass and a temperature of −17° C. at which a peak value of loss tangent (tan δ) at a frequency of 1 Hz was exhibited.

Next, the adhesive layer before the aging was attached to each of the both surfaces of a substrate including a black polyolefin foam (1) (a foam manufactured by Sekisui Chemical Co., Ltd. and surface-treated by corona treatment to have a wetting index of 60 mN/m, thickness: 200 μm, apparent density: 0.20 g/cm³, 25% compressive strength: 52 kPa, flow-direction tensile strength: 495 N/cm², width-direction tensile strength: 412 N/cm²) and then laminated at 23° C. with a roll under a linear pressure of 5 kg/cm. Then, the resultant laminate was allowed to stand in an environment of 40° C. for 48 hours to form a double-sided adhesive tape having a thickness of 350 μm.

The thickness of the foam was measured by using a dial thickness gauge model G manufactured by Ozaki MFG. Co., Ltd. The thickness of the double-sided adhesive tape was measured by using a dial thickness gauge model G manufactured by Ozaki MFG. Co., Ltd. after removing the release film. The tensile strength of the foam was measured as strength at break when a specimen obtained by cutting the foam into a size having a reference line length of 2 cm (flow direction and width direction of the foam substrate) and a width of 1 cm was stretched at a tensile speed of 300 mm/min. The thickness and tensile strength of a foam and the thickness of a double-sided adhesive tape used in Example 2 or later were measured by the same method as described above.

### Example 2

A double-sided adhesive tape having a thickness of 350 μm was formed by the same method as in Example 1 except that the adhesive composition (B) was used in place of the adhesive composition (A), and 1.33 parts by mass of “Coronate L-45” (manufactured by Nippon Polyurethane Industry Co., Ltd., isocyanate-based crosslinking agent, solid content 45% by mass) was used relative to 100 parts by mass of the adhesive composition (B).

An adhesive layer formed by allowing the adhesive layer to stand (aging) in an environment of 40° C. for 48 hours had a gel fraction of 37% by mass and a temperature of 2° C. at which a peak value of loss tangent (tan δ) at a frequency of 1 Hz was exhibited.

### Example 3

A double-sided adhesive tape having a thickness of 350 μm was formed by the same method as in Example 1 except that the adhesive composition (C) was used in place of the adhesive composition (A), and 1.0 parts by mass of “Coronate L-45” (manufactured by Nippon Polyurethane Industry Co., Ltd., isocyanate-based crosslinking agent, solid content 45% by mass) was used relative to 100 parts by mass of the adhesive composition (C).

An adhesive layer formed by allowing the adhesive layer to stand (aging) in an environment of 40° C. for 48 hours had a gel fraction of 42% by mass and a temperature of −28° C. at which a peak value of loss tangent (tan δ) at a frequency of 1 Hz was exhibited.

### Example 4

A double-sided adhesive tape having a thickness of 350 μm was formed by the same method as in Example 1 except that the adhesive composition (D) was used in place of the adhesive composition (A), and 1.6 parts by mass of “Coronate L-45” (manufactured by Nippon Polyurethane Industry Co., Ltd., isocyanate-based crosslinking agent, solid content 45% by mass) was used relative to 100 parts by mass of the adhesive composition (D).

An adhesive layer after aging in an environment of 40° C. for 48 hours had a gel fraction of 40% by mass and a temperature of −5° C. at which a peak value of loss tangent (tan δ) at a frequency of 1 Hz was exhibited.

### Example 5

A double-sided adhesive tape having a thickness of 400 μm was formed by the same method as in Example 1 except that in place of the black polyolefin foam (1), a black polyolefin foam (2) was used (a foam manufactured by Sekisui Chemical Co., Ltd. and surface-treated by corona treatment to have a wetting index of 60 mN/m, thickness: 300 μm, apparent density: 0.20 g/cm³, 25% compressive strength: 90 kPa, flow-direction tensile strength: 530 N/cm², width-direction tensile strength: 340 N/cm²) and the thickness of the adhesive on each side after drying was changed to 50 μm from 75 μm.

### Example 6

A double-sided adhesive tape having a thickness of 300 μm was formed by the same method as in Example 1 except that in place of the black polyolefin foam (1), a black polyolefin foam (3) was used (a foam manufactured by Sekisui Chemical Co., Ltd. and surface-treated by corona treatment to have a wetting index of 60 mN/m, thickness: 140 μm, apparent density: 0.40 g/cm³, 25% compressive strength: 140 kPa, flow-direction tensile strength: 994 N/cm², width-direction tensile strength: 713 N/cm²) and the thickness of the adhesive layer after drying was changed to 80 μm from 75 μm.

### Example 7

A double-sided adhesive tape having a thickness of 200 μm was formed by the same method as in Example 5 except that in place of the black polyolefin foam (2), a black polyolefin foam (4) was used (a foam manufactured by Sekisui Chemical Co., Ltd. and surface-treated by corona treatment to have a wetting index of 60 mN/m, thickness: 100 μm, apparent density: 0.33 g/cm³, 25% compressive strength: 70 kPa, flow-direction tensile strength: 799 N/cm², width-direction tensile strength: 627 N/cm²).

### Example 8

A double-sided adhesive tape having a thickness of 250 μm was formed by the same method as in Example 1 except that the thickness of the adhesive layer on each side after drying was changed to 25 μm from 75 μm.

### Example 9

A double-sided adhesive tape having a thickness of 300 μm was formed by the same method as in Example 1 except that in place of the black polyolefin foam (1), a black polyolefin foam (6) was used (a foam manufactured by Sekisui Chemical Co., Ltd. and surface-treated by corona treatment to have a wetting index of 60 mN/m, thickness: 170 μm, apparent density: 0.46 g/cm³, 25% compressive strength: 340 kPa, flow-direction tensile strength: 1030 N/cm², width-direction tensile strength: 710 N/cm²) and the thickness of the adhesive layer on each side after drying was changed to 65 μm from 75 μm.

### Example 10

A double-sided adhesive tape having a thickness of 400 μm was formed by the same method as in Example 8 except that in place of the black polyolefin foam (1), a black polyolefin foam (7) was used (a foam manufactured by Sekisui Chemical Co., Ltd. and surface-treated by corona treatment to have a wetting index of 60 mN/m, thickness: 300 μm, apparent density: 0.13 g/cm³, 25% compressive strength: 40 kPa, flow-direction tensile strength: 214 N/cm², width-direction tensile strength: 208 N/cm²) and the thickness of the adhesive layer on each side after drying was changed to 50 μm from 75 μm.

### Comparative Example 1

A double-sided adhesive tape having a thickness of 200 μm was formed by the same method as in Example 1 except that in place of the black polyolefin foam (1), a polyester film 1 was used (“S105#25” manufactured by Toray Industries, Inc. and surface-treated by corona treatment to have a wetting index of 60 mN/m, thickness: 25 μm) and the thickness of the adhesive layer was 88 μm.

### Comparative Example 2

A double-sided adhesive tape having a thickness of 250 μm was formed by the same method as in Example 2 except that in place of the black polyolefin foam (1), a polyester film 2 was used (“S105#50” manufactured by Toray Industries, Inc. and surface-treated by corona treatment to have a wetting index of 60 mN/m, thickness: 50 μm) and the thickness of the adhesive layer was 100 μm.

### Comparative Example 3

A double-sided adhesive tape having a thickness of 200 μm was formed by the same method as in Example 34 except that in place of the black polyolefin foam (1), a nonwoven fabric was used (“Mikiron 805” manufactured by Miki Tokushu Paper Mfg. Co., Ltd., weight per unit area: 14 g/cm³) and the thickness of the adhesive layer was 90 μm.

The foam substrates used in the examples and comparative examples and the double-sided adhesive tapes produced in the examples and comparative examples were evaluated as described below. The results obtained are shown in tables below.

### [Elongation at Break (Tensile Elongation)]

The foam substrate processed into a specimen having a reference line distance of 2 cm (flow direction and width direction of the foam substrate) and a width of 1 cm was stretched at a tensile speed of 300 mm/min to measure an elongation at break.

### [Compressive Displacement]

1) A 2 cm square adhesive tape was attached to a 10 cm square smooth aluminum plate having a thickness of 9 mm at 23° C. and allowed to stand at 23° C. for 24 hours in a state the release sheet was removed, thereby forming a specimen.

2) Next, a tensile tester provided with a stainless probe having a diameter of 7 mm was used, and the adhesive tape was compressed at a rate of 0.5 m/min with 5 N/cm² to determine a displacement.

### [Tan δ Peak Value of Adhesive Tape]

The adhesive tape processed into a circle with a diameter of 8 mm was held between parallel disks having a diameter of 8 mm in a measurement portion of the viscoelasticity tester (manufactured by TA Instruments Japan Inc., trade name: ARES G2) used, and the loss tangent (tan δ=loss elastic modulus (G″)/storage elastic modulus (G′)) was measured from −50° C. to 150° C. at a heating rate of 2° C./min and a frequency of 1 Hz to determine a maximum value. When there were two or more peaks, a larger value was used.

### [Touch Feedback Characteristic]

1) A frame-shaped sample having an outer shape of 64 mm×43 mm and a width of 2 mm was formed by using the double-sided adhesive tape produced as described above and attached to an acryl plate 1 having a thickness of 2 mm and an outer shape of 65 mm×45 mm.

2) Next, the acryl plate with the double-sided adhesive tape was placed at a center of an acryl plate 2 having a thickness of 2 mm and an outer shape of 100 mm×50 mm so that the double-sided adhesive tape side was in contact with the acryl plate 2, pressed by one reciprocation of a 2 kg roller from the ends, and then allowed to stand at 23° C. for 24 hours to form a specimen.

3) On the other hand, a comparative specimen was formed by the same operations as 1) and 2) except using a double-sided adhesive tape including a polyester film core (film: thickness 25 μm and transparent, adhesive layer: formed by the same method as in Example 1 except that the thickness after drying was 88 μm).

4) A piezoelectric element was bonded to the short-side end of the upper surface of the acryl plate 1, and then the long-side portion of the acryl plate 2 of the specimen was held with a hand of the participant in a state where the acryl plate 2 faced upward. When the specimen in the state of being held was vibrated by applying electrical current to the piezoelectric element, a vibration state of the acryl plate 2 was evaluated.

5) An attenuation effect was evaluated by comparison with a vibration state of the comparative specimen formed in 3) on the basis of criteria below. 6) The evaluation was performed by 5 participants, and the evaluation result obtained by the most number of participants was regarded as an evaluation result of each specimen.

A: Significant attenuation

B: Attenuation

C: Substantially no attenuation

### [Face Adhesive Strength]

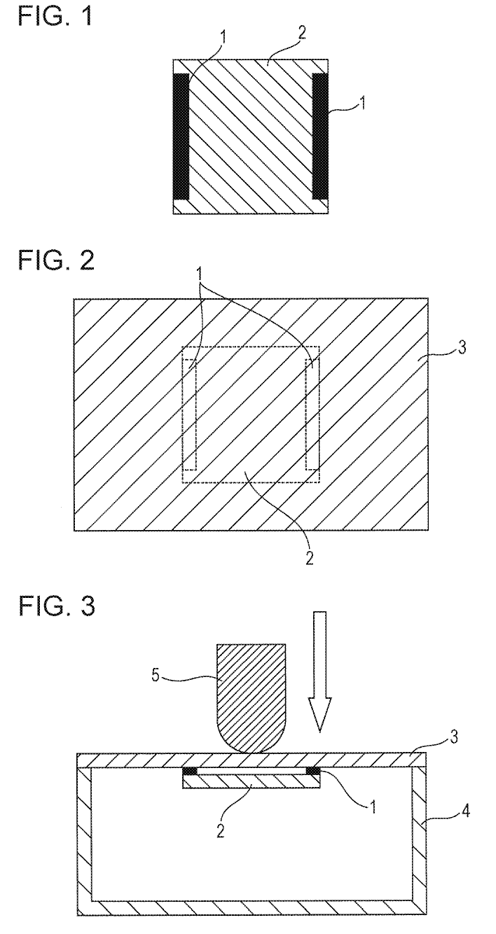

1) Two double-sided adhesive tapes having a width of 5 mm and a length of 40 mm were attached in parallel at a space of 40 mm therebetween on a 50 mm square acryl plate having a thickness of 2 mm (Mitsubishi Rayon Co., Ltd., Acrylite MR200 “trade name”, hue: transparent) at 23° C. (FIG. 1).

2) Next, the acryl plate with the double-sided adhesive tapes formed in 1) was attached to a rectangular ABS plate of 100×150 mm (Tafuesu R EAR003 manufactured by Sumitomo Bakelite Co. Ltd. hue: natural, no emboss) having a thickness of 2 mm and a hole with a diameter of 10 mm provided at the center thereof so that the center of the acryl plate coincided with the center of the ABS plate. Then, the plates were pressed by one reciprocation of a 2 kg roller and then allowed to stand at 23° C. for 1 hour to form a specimen (FIG. 2).

3) The acryl plate was pushed at 10 mm/min from the ABS side of the specimen through the hole of the ABS plate using a tensile tester provided with a stainless probe having a diameter of 8 mm, and strength was measured when the ABS plate was separated (FIG. 3).

### [Impact Resistance Test]

1) The weakly adhesive surfaces of two double-sided adhesive tapes having a length of 40 mm and a width of 5 mm were parallel attached at a space of 40 mm to an acryl plate (Mitsubishi Rayon Co., Ltd., Acrylite L “trade name”, hue: transparent) having a thickness of 2 mm and an outer shape of 50 mm×50 mm (FIG. 1). Then, the acryl plate with the double-sided tapes was attached to a central portion of an ABS plate (Tafuesu R manufactured by Sumitomo Bakelite Co. Ltd. hue: natural, no emboss) having a thickness of 2 mm and an outer shape of 150 mm×100 mm (FIG. 2). Then, the plates were pressed by one reciprocation of a 2 kg roller and then allowed to stand at 23° C. for 1 hour to form a specimen.

2) A U-shaped measurement base (made of aluminum and having a thickness of 5 mm) having a length of 150 mm, a width of 100 mm, and a height of 45 mm was installed on a pedestal of a DuPont-type impact tester (manufactured by Tester Sangyo Co., Ltd.), and a specimen was placed on the measurement base so that the acryl plate faced downward (FIG. 3). An impact shaft made of stainless having a diameter of 15 mm, a mass of 300 g, and an impact-applying end-side shape with a curvature of 3/16 inches was dropped from a height of 10 cm on a central portion on the ABS side 5 times at an interval of 10 seconds, and whether or not tape peeling or breakage occurred in the specimen was evaluated. When neither peeling nor breakage occurred in the tape, the drop height was increased at an internal of 10 cm, and dropping was continuously repeated 5 times. When peeling or breakage of the tape was recognized, the height was measured.

A: Neither peeling nor breakage occurred in the tape even after the test at a height of 80 cm.

B: Peeling or breakage occurred in the tape after the test at a height of 50 to 70 cm.

C: Peeling or breakage occurred in the tape after the test at a height of 40 cm.

### [Water-Proof Test]

1) A frame-shaped sample having an outer shape of 64 mm×43 mm and a width of 2 mm was formed by using the double-sided adhesive tape produced as described above, and then attached to an acryl plate 1 having a thickness of 2 mm and an outer shape of 65 mm×45 mm.

2) Next, the acryl plate with the double-sided tape formed was placed on a central portion of another acryl plate 2 having a thickness of 2 mm and an outer shape of 65 mm×45 mm so that the double-sided adhesive tape was in contact with the other acryl plate, and then the plates were pressed by one reciprocation of a 2 kg roller and then allowed to stand at 23° C. for 24 hours to form a specimen.

3) The specimen was allowed to stand at a water depth of 1 m for 30 minutes (according to JIS C0920 IPX7), and then the presence of water intrusion into a frame of the frame-shaped double-sided adhesive tape was evaluated.

A: No water intrusion

B: Occurrence of water intrusion

TABLE 1

| | | Example 1 | Example 2 | Example 3 | Example 4 | Example 5 | Example 6 |
|---|---|---|---|---|---|---|---|
| Black polyolefin foam | | (1) | (1) | (1) | (1) | (2) | (3) |
| Elongation | Flow | 445 | 445 | 445 | 445 | 530 | 535 |
| at break | direction (%) | | | | | | |
| | Width | 261 | 261 | 261 | 261 | 420 | 344 |
| | direction (%) | | | | | | |
| Adhesive composition | | A | B | C | D | A | A |
| Thickness of | | 75 | 75 | 75 | 75 | 50 | 80 |
| adhesive layer (μm) | | | | | | | |
| Thickness of double-sided | | 350 | 350 | 350 | 350 | 400 | 300 |
| adhesive tape (μm) | | | | | | | |
| Compressive displacement | | 58 | 58 | 58 | 52 | 65 | 35 |
| (μm) | | | | | | | |
| Tan δ of | [° C.] | −5.4 | 16.4 | −14.2 | −2.0 | −3.5 | −11.3 |
| double-sided | Value | 0.73 | 0.73 | 0.78 | 0.75 | 0.65 | 1.23 |
| adhesive tape | | | | | | | |

| | | | | | | |
|---|---|---|---|---|---|---|
| Touch feedback | A | B | A | A | B | B |
| characteristic | | | | | | |
| Face adhesive strength | 163 | 187 | 100 | 160 | 170 | 160 |
| (N/4 cm²) | | | | | | |
| Impact resistance | A | A | A | A | A | A |
| Water proof | A | A | A | A | A | A |

TABLE 2

| | | Example | Example | Example | Example | Comparative | Comparative | Comparative |
|---|---|---|---|---|---|---|---|---|
| | | 7 | 8 | 9 | 10 | Example 1 | Example 2 | Example 3 |
| Black polyolefin foam | | (4) | (1) | (6) | (7) | | | |
| Substrate | | — | — | — | — | Polyester | Polyester | Nonwoven |
| | | | | | | film 1 | film 2 | fabric |
| Elongation | Flow | 458 | 445 | 510 | 417 | | | |
| at break | direction (%) | | | | | | | |
| | Width | 254 | 261 | 427 | 240 | | | |
| | direction (%) | | | | | | | |
| Adhesive composition | | A | A | A | A | A | B | C |
| Thickness of | | 50 | 25 | 65 | 50 | 88 | 100 | 88 |
| adhesive layer (μm) | | | | | | | | |
| Thickness of double-sided | | 200 | 250 | 300 | 400 | 200 | 250 | 200 |
| adhesive tape (μm) | | | | | | | | |
| Compressive displacement | | 32 | 53 | 24 | 100 | 8 | 7 | 8 |
| (μm) | | | | | | | | |
| Tan δ of | [° C.] | −7.4 | −4.8 | −12.5 | −1.2 | −16.0 | 2.0 | −28.0 |
| double-sided | Value | 0.81 | 0.62 | 1.25 | 0.42 | 1.98 | 2.10 | 1.56 |
| adhesive tape | | | | | | | | |

| | | | | | | | |
|---|---|---|---|---|---|---|---|
| Touch feedback | B | B | B | A | C | C | C |
| characteristic | | | | | | | |
| Face adhesive strength | 150 | 140 | 150 | 124 | 140 | 190 | 80 |
| (N/4 cm²) | | | | | | | |
| Impact resistance | B | A | A | B | B | C | B |
| Water proof | A | A | A | A | B | B | B |

As in Examples 1 to 10, the adhesive tape of the present invention can realize the good tactile feedback function when used for fixing a touch panel device having the tactile feedback function. Also, the adhesive tape has excellent drop impact resistance and followability. On the other hand, the adhesive tapes of Comparative Examples 1 to 3 are poor in the touch feedback characteristic and are thus unsuitable in use for fixing a touch panel device having the tactile feedback function.

### REFERENCE SIGNS LIST

1 adhesive tape
2 acryl plate
3 ABS plate
4 U-shape measurement base
5 impact shaft

1. An adhesive tape comprising a foam substrate layer and an adhesive layer, wherein the adhesive tape is used for fixing a touch panel device having the function of sensing contact with or approach to the touch panel device and giving tactile feedback, and when the adhesive tape is compressed in the thickness direction with a compressive load of 5 N/cm², a displacement is 12 μm or more and less than 130 μm.

2. The adhesive tape according to claim 1, wherein the thickness is 60 μm to 500 μm.

3. The adhesive tape according to claim 1, wherein the foam substrate layer has a thickness of 350 μm or less and an apparent density of 0.13 g/cm³ to 0.67 g/cm³.

4. The adhesive tape according to claim 1, wherein the foam substrate layer is a polyolefin foam substrate layer.

5. The adhesive tape according to claim 1, wherein the adhesive layer is formed by using an acrylic adhesive composition.

6. The adhesive tape according to claim 1, wherein the adhesive layer has a thickness of 10 μm to 150 μm.

7. The adhesive tape according to claim 1, wherein the foam substrate has a tensile strength of 150 N/cm² to 1700 N/cm².

8. The adhesive tape according to claim 1, wherein the maximum value of loss tangent measured at a frequency of 1 Hz is 0.36 or more.

9. The adhesive tape according to claim 1, wherein the adhesive layer is an adhesive layer formed by using an acrylic adhesive composition containing an acrylic polymer, which is produced by polymerizing a monomer component containing (meth)acrylate having an alkyl group having 1 to 12 carbon atoms and a vinyl monomer having a carboxyl group, and a polymerized rosin ester-based tackifier resin.

10. An electronic apparatus comprising the touch panel device fixed to a casing through the adhesive tape according to any one of claims 1 to 9.
